(19) United States
(12) Patent Application Publication
(10) Pub. No.: US 2026/0359454 A1
(43) Pub. Date: Nov. 12, 2026

(54) METHOD FOR PROCESSING PERSONAL DATA, AND ASSOCIATED SYSTEM AND COMPUTER PROGRAM

(71) Applicant: IDEMIA PUBLIC SECURITY FRANCE, Courbevoie (FR)

(72) Inventors: Hervé CHABANNE, Courbevoie (FR); Alberto IBARRONDO, Courbevoie (FR)

(73) Assignee: IDEMIA PUBLIC SECURITY FRANCE, Courbevoie (FR)

(21) Appl. No.: 19/484,029

(22) PCT Filed: Jun. 12, 2024
(86) PCT No.: PCT/EP2024/066152

§ 371 Date: Nov. 13, 2025

(30) Foreign Application Priority Data
Jun. 13, 2023 (FR) FR2306007

(51) Int. Cl. G06F 21/60; G06F 7/483; G06F 21/62

(52) U.S. Cl. CPC G06F 21/602; G06F 7/483; G06F 21/6245

(57) ABSTRACT

A method for processing personal data, each personal datum being a vector of components that are homomorphically encrypted in the form of cryptograms of N components in a group provided with an addition and a multiplication, a reference cryptogram is the image of the concatenation of the components of the same index of N reference personal data, a candidate cryptogram is the image of the concatenation of N components having the value of one and the same component of a candidate personal datum, and the method comprises: (a) obtaining intermediate cryptograms by applying a Hadamard product of a reference cryptogram and a candidate cryptogram, which differ from one another, and (b) obtaining a final cryptogram by vector addition of the intermediate cryptograms, the final cryptogram being the image of the distance between the candidate personal datum and N reference personal data.

The invention relates to a method for processing personal data. The invention also relates to an associated system and computer program.

Identification schemes are already known in which a user presents, to a trustworthy processing unit, for example to a unit belonging to a customs office, an airport, etc., a biometric datum freshly acquired from the user (called the candidate biometric datum) that the unit compares with one or more reference biometric data recorded in a database to which it has access.

The database contains the reference biometric data of authorized individuals (such as the passengers of a flight prior to boarding).

Such a solution is satisfactory, but raises the problem of keeping the database of reference biometric data confidential in order to guarantee the privacy of the users.

To avoid any cleartext manipulation of the biometric data, it is possible to use an encryption of a homomorphic cryptographic scheme and to carry out processing on the biometric data (typically distance calculations) in the encrypted domain. Specifically, a homomorphic cryptographic scheme makes it possible to perform certain mathematical operations on pre-viously encrypted data instead of cleartext data. Thus, for a given calculation, it becomes possible to encrypt the data, do certain calculations associated with said given calculation on the encrypted data, and then decrypt the encrypted data, the same result being obtained as when said given calculation is performed directly on the cleartext data.

To limit the calculations in the encrypted domain while benefiting from a parallel computer architecture, for example an SIMD architecture (STMD being the abbreviation of Single Instruction Multiple Data), allowing a given operation to be carried out on N data, one known method for processing personal data is implemented by a system storing a database of K reference personal data that are homomorphically encrypted into the form of

$$\frac{K \times l}{N}$$

reference cryptograms in a group containing a first operation, namely an addition, and a second operation, namely a multiplication, the method comprising determination, in the encrypted domain, for each reference personal datum of the database, of a distance between a given candidate personal datum and said reference personal datum, said distance being a scalar product of the candidate personal datum and of said reference personal datum. The candidate personal datum and each reference personal datum are vectors of l components, and each reference cryptogram is a vector of N components, with K, N and l natural numbers strictly greater than 1, and N a multiple of l. In this known method, each reference cryptogram is the image, by an encryption function of a homomorphic cryptographic scheme, of the concatenation of all the components of

$$\frac{N}{l}$$

reference personal data.

This method determines, in the encrypted domain, distances between the candidate personal datum and

$$\frac{N}{l}$$

reference personal data with the following steps:
a) obtaining an intermediate cryptogram taking the form of a vector of

$$\frac{N}{l}$$

pluralities of l components, by applying a Hadamard product between a candidate cryptogram and the reference cryptogram associated with the

$$\frac{N}{l}$$

reference personal data, the candidate cryptogram being the image, by the encryption function, of the concatenation of

$$\frac{N}{l}$$

iterations of the candidate personal datum (i.e. of

$$\frac{N}{l}$$

iterations of all the components of the candidate personal datum),
b) obtaining a final cryptogram taking the form of a vector of

$$\frac{N}{l}$$

pluralities of l components, each component of a plurality of l components of the final cryptogram resulting from application of the first operation between all the components of a given plurality of l components of the intermediate cryptogram.

However, this solution remains expensive in terms of computation time and memory space.

This restriction limits the speed of identification and the number of identifications achieva-ble in a given time.

In order to overcome these drawbacks, the present invention provides, according to a first aspect, a method for processing personal data, said method being implemented by a system storing a database of K reference personal data that are homomorphically encrypted into the form of

$$⌈ \frac{K}{N} ⌉ \times l$$

reference cryptograms in a group containing a first operation and a second operation,
said method comprising determination, in the encrypted domain, for each reference personal datum of the database, of a distance between a given candidate personal datum and said reference personal datum, and
where the first operation is an addition and the second operation is a multiplication,
for every p ranging from 1 to K, the reference personal datum of rank p is a vector of l components having respective indices ranging from 1 to l,
for every q ranging from 1 to

$$⌈ \frac{K}{N} ⌉ \times l ,$$

the reference cryptogram of rank q is a vector of N components having respective indices ranging from 1 to N, and
the candidate personal datum is a vector of l components having respective indices ranging from 1 to l,
with K, N and l natural numbers strictly greater than 1,
   said method being characterized in that:
for every i ranging from 1 to

$$⌈ \frac{K}{N} ⌉$$

and for every j ranging from 1 to l, the reference cryptogram of rank (i−1)×l+j is the image, by an encryption function of a homomorphic cryptographic scheme, of the concatenation of the components of index j of each reference personal datum having a rank between i×N−N+1 and i×N,
for every i ranging from 1 to

$$⌈ \frac{K}{N} ⌉ ,$$

the determination in the encrypted domain of the distances between the candidate personal datum and each reference personal datum having a rank between i×N−N+1 and i×N comprises:
   a) for every j ranging from 1 to l, obtaining an intermediate cryptogram of rank (i−1)×l+j taking the form of a vector of N components, by applying a Hadamard product between the reference cryptogram of rank (i−1)×l+j and a candidate cryptogram of rank j, the candidate cryptogram of rank j being the image, by the encryption function, of the concatenation of N components each having the value of the component of index j of the candidate personal datum,
   b) obtaining a final cryptogram of rank i taking the form of a vector of N components, by applying a vector addition between the 1 intermediate cryptograms obtained,
the distance between the candidate personal datum and a reference personal datum of rank p being the antecedent, by the encryption function of the component of index p−

$$( ⌈ \frac{p}{N} ⌉ - 1 ) \times N ,$$

of the final cryptogram of rank

$$⌈ \frac{p}{N} ⌉ .$$

According to some advantageous and non-limiting features:
the method further comprises a step of obtaining the

$$⌈ \frac{K}{N} ⌉ \times l$$

reference cryptograms, during which step, for every i ranging from 1 to

$$⌈ \frac{K}{N} ⌉$$

and for every j ranging from 1 to l, the reference cryptogram of rank (i−1)×l+j is obtained by applying the encryption function, to the concatenation of the components of index j of each reference personal datum having a rank between i×N−N+1 and i×N;
the data storage module stores the

$$⌈ \frac{K}{N} ⌉ \times l$$

reference cryptograms;
the

$$⌈ \frac{K}{N} ⌉ \times l$$

reference cryptograms form the homomorphically encrypted representation of the K reference personal data;
the method further comprises a step of obtaining the candidate cryptograms, during which step, for every j ranging from 1 to l, the candidate cryptogram of rank j is obtained by applying the encryption function to the concatenation of N components each having the value of the component of index j of the candidate personal datum;
the candidate personal datum is acquired using an acquisition interface;
the method further comprises a step of decrypting the final cryptograms;
the decryption of each final cryptogram is by application of a decryption function of the homomorphic cryptographic scheme, to the final cryptogram in question or to the components of said final cryptogram;
the personal data are biometric data, in particular data representative of faces;
K is a multiple of N;
the homomorphic cryptographic scheme is the Brakerski-Fan-Vercauteren scheme or the Cheon-Kim-Kim-Song scheme;
when the system is able to perform parallel computing, it for example having an SIMD architecture, allowing a given operation to be carried out on M data, the value of N is preferably M if the homomorphic cryptographic scheme is the Brakerski-Fan-Vercauteren scheme, and

$$⌊ \frac{M}{2} ⌋$$

if the homomorphic cryptographic scheme is the Cheon-Kim-Kim-Song scheme.

According to a second aspect, the invention provides a computer program comprising instructions executable by a processor and configured to implement a method for processing personal data such as defined above, when these instructions are executed by the processor.

This program may use any programming language, and take the form of source code, object code, or code intermediate between source code and object code, such as code in a par-tially compiled form, or in any other desirable form.

According to a third aspect, the invention provides a non-transient computer-readable medium storing instructions that are able to be executed by a processor so as to execute a method for processing personal data such as defined above.

A tangible or non-transient medium may comprise a storage medium such as a hard drive reader, a magnetic tape device or a semiconductor memory device and the like.

At least some of the methods according to the invention may be computer-implemented.

As a result, the present invention may be embodied entirely in the form of hardware, entirely in the form of software (comprising firmware, resident software, microcode, etc.) or in a form combining software and hardware aspects that may each be generally referred to as a “module” here.

According to a fourth aspect, the invention provides a system for processing personal data, comprising:
a data storage module storing a database of K reference personal data that are homomorphically encrypted into the form of

$$⌈ \frac{K}{N} ⌉ \times l$$

reference cryptograms in a group containing a first operation and a second operation, and
a data-processing module configured to determine, in the encrypted domain, for each reference personal datum of the database, a distance between a given candidate personal datum and said reference personal datum,
   where:
the first operation is an addition and the second operation is a multiplication,
for every p ranging from 1 to K, the reference personal datum of rank p is a vector of l components having respective indices ranging from 1 to l,
for every q ranging from 1

$$⌈ \frac{K}{N} ⌉ \times l ,$$

the reference cryptogram of rank q is a vector of N components having respective indices ranging from 1 to N, and
the candidate personal datum is a vector of l components having respective indices ranging from 1 to l,
with K, N and l natural numbers strictly greater than 1, the system being characterized in that:
for every i ranging from 1 to

$$⌈ \frac{K}{N} ⌉$$

and for every j ranging from 1 to l, the reference cryptogram of rank (i−1)×l+j is the image, by an encryption function of a homomorphic cryptographic scheme, of the concatenation of the components of index j of each reference personal datum having a rank between i×N−N+1 and i×N,
for every i ranging from 1 to

$$⌈ \frac{K}{N} ⌉ ,$$

the determination in the encrypted domain, by the data-processing module, of the distances between the candidate personal datum and each reference personal datum having a rank between i×N−N+1 and i×N, comprises:
   a) for every j ranging from 1 to l, obtaining an intermediate cryptogram of rank (i−1)×l+j taking the form of a vector of N components, by applying a Hadamard product between the reference cryptogram of rank (i−1)×l+j and a candidate cryptogram of rank j, the candidate cryptogram of rank j being the image, by the encryption function, of the concatenation of N components each having the value of the component of index j of the candidate personal datum,
   b) obtaining a final cryptogram of rank i taking the form of a vector of N components, by applying a vector addition between the l intermediate cryptograms obtained,
the distance between the candidate personal datum and a reference personal datum of rank p being the antecedent, by the encryption function of the component of index

$$p - ( ⌈ \frac{p}{N} ⌉ - 1 ) \times N ,$$

of the final cryptogram of rank

$$⌈ \frac{p}{N} ⌉ .$$

The system for processing personal data may further comprise an acquisition interface configured to acquire the candidate personal datum.

According to one embodiment, the personal data are biometric data and the system comprises a biometric acquisition means for obtaining the candidate personal datum.

Preferably, the data-processing module is able to perform parallel computing, the data-processing module for example having an SIMD architecture, allowing a given operation to be performed on M data.

According to one embodiment, when the homomorphic cryptographic scheme is the Brak-erski-Fan-Vercauteren scheme, M and N preferably have the same value, and when the homomorphic cryptographic scheme is the Cheon-Kim-Kim-Song scheme, the value of N is preferably

$$⌊ \frac{M}{2} ⌋ .$$

This system may be configured to implement each of the possible embodiments envisaged for the method for processing biometric data such as defined above.

Of course, the various features, variants and embodiments of the invention may be com-bined with one another in a variety of combinations provided that they are not incompati-ble or mutually exclusive.

Other features and advantages of the present invention will become apparent from the description given below, with reference to the appended figures, which illustrate examples of embodiment that are completely non-limiting in nature.

In the figures:

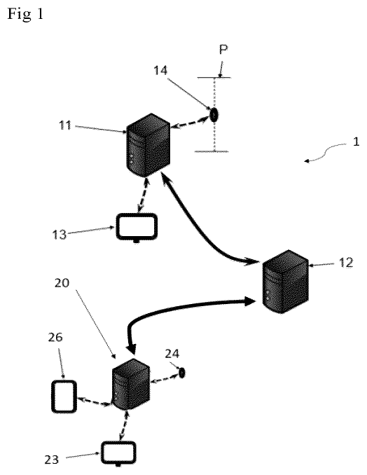

FIG. 1 schematically shows one preferred embodiment of a system for implementing a method according to the invention;

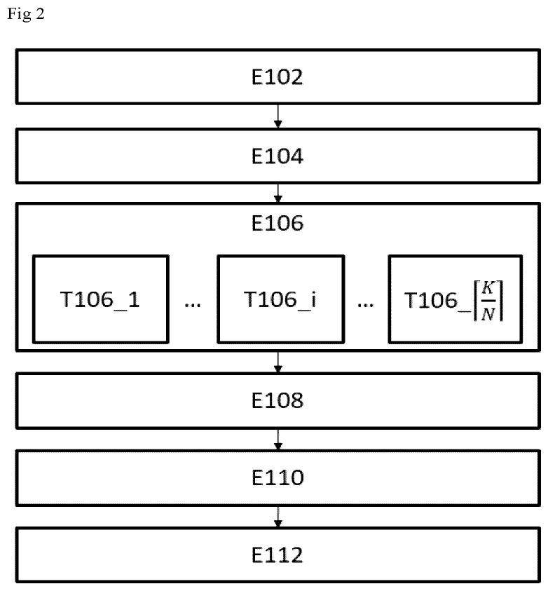

FIG. 2 illustrates the steps of one embodiment of a method for processing personal data, according to the invention.

FIG. 1 schematically shows a system for processing personal data with a view to identi-fying individuals.

The system 1 typically identifies a candidate individual, i.e. compares a candidate personal datum X (freshly acquired from the candidate individual), with all the reference personal data of a database, in order to determine the identity of the candidate individual.

By candidate personal datum, what is meant here is a personal datum intended to be acquired in a controlled and intentional manner by an acquisition interface, for example by way of a biometric acquisition means, of a user interface or by optical read-out.

The candidate personal datum X is a vector of l components (X[1], . . . , X[l]) having respective indices ranging from 1 to l, with l a natural number strictly greater than 1.

The database contains K reference personal data, with K a natural number strictly greater than 1, and for every p ranging from 1 to K, the reference personal datum Y^{(P)} of rank p in the database is a vector of l components (Y^{(p)}[1], . . . , Y^{(p)}[l]) having respective indices ranging from 1 to l.

By personal datum, what is in particular meant is a biometric datum (and this example will be considered in the remainder of the present description), but it will be understood that it may be a question of any datum specific to an individual and based on which a user may be identified, such as an alphanumeric datum, a signature, etc.

This system 1 is a piece of equipment possessed and controlled by an entity for which identification must be performed, for example a government entity, a customs entity, a company, etc. In the remainder of the present description, the example of an airport will be considered, the system 1 typically aiming to control access by passengers of a flight before they board.

The system 1 comprises a data-processing module 11, i.e. a computer such as for example a processor, a microprocessor, a controller, a microcontroller, an FPGA, etc. This computer is configured to execute code instructions with a view to implementing certain steps of the method for processing personal data that will be described below.

Preferably, the data-processing module 11 is able to perform parallel computing, the data-processing module 11 for example having an SIMD architecture, allowing a given operation to be performed on M data, M being a natural number strictly greater than 1.

The system 1 also comprises a data storage module 12 (a memory, for example a hard disk or a flash memory) and, where appropriate, a user interface 13 (typically a screen and/or a keyboard) and/or biometric acquisition means 14 (see below).

In the biometric preferred embodiment, the system 1 is capable of generating a biometric datum called the candidate biometric datum from a biometric feature of an individual. The biometric feature may for example be the shape of the face, one or more fingerprints, or one or more irises of the individual. The biometric datum is extracted by processing the image of the biometric feature in a way that depends on the nature of the biometric feature.

Various image-processing operations for extracting biometric data are known to those skilled in the art. By way of non-limiting example, extraction of the biometric datum may comprise extraction (in particular by a neural network) of a vector representative of particular points, or of a shape of the face in the case where the image is an image of the face of the individual.

In this regard, the biometric acquisition means 14 typically consist of an image sensor, for example a digital photographic camera or a digital video camera, configured to acquire at least one image of a biometric feature of an individual (see below).

Generally, there will always be one candidate personal datum and at least one reference personal datum to be compared—if alphanumeric personal data are being used, the candidate datum may simply be entered on the user interface 13 or, for example, be obtained by optical read-out from an image.

The data storage module 12 stores a database of reference personal data, i.e. at least one “expected” personal datum of an authorized individual, for example the passengers regis-tered for the flight. Each reference personal datum is advantageously a datum recorded in an identity document of the individual. For example, the personal datum may be a biometric datum obtained from a facial image featuring on an identity document (a passport for example) or indeed obtained from an image of the face, of at least one fingerprint, or of at least one iris of the individual recorded in a radio-frequency chip contained in the document.

Each reference personal datum is stored homomorphically encrypted, i.e. encrypted according to a homomorphic cryptographic scheme. Any homomorphic cryptographic scheme having the required properties may be used, for example the Brakerski-Fan-Vercauteren (BFV) scheme or the Cheon-Kim-Kim-Song (CKKS) scheme.

It will be assumed that the database of reference personal data has been populated in advance. For example, the passengers may have submitted their identity document in advance.

Where appropriate, the system 1 may also comprise an enrolment module 20, another user interface 23 (typically a screen and/or keyboard), and/or other biometric acquisition means 24 and/or a document reader 26 with a view to populating the database of reference personal data.

The enrolment module 20 is another computer, configured to execute code instructions with a view to implementing certain steps of the method for processing personal data that will be described below.

The information provided in respect of the biometric acquisition means 14 applies to the other biometric acquisition means 24.

Said other biometric acquisition means 24 allow at least one reference biometric datum to be obtained.

Generally, a reference biometric datum is generated by the enrolment module 20 from a biometric feature supplied by one of the other biometric acquisition means 24, but the other biometric acquisition means 24 may comprise their own processing means for extracting the reference biometric datum. A such other biometric acquisition means may where appropriate encrypt the reference biometric datum on the fly by applying an encryption function of the homomorphic cryptographic scheme into the form of a reference cryptogram (see the method described below).

According to another possibility, the enrolment module 20 may encrypt the reference biometric datum by applying an encryption function of the homomorphic cryptographic scheme into the form of a reference cryptogram.

The document reader 26 is typically an image sensor, such as for example a digital photographic camera or a digital video camera, configured to acquire an image of an identity document (a passport for example), and/or a contact-based or contactless communication means (for example NFC, UHF, etc.) configured to read the contents of a chip of an identity document.

The document reader 26 allows a reference personal datum to be obtained from an identity document of an individual.

If alphanumeric personal data are used, the reference personal datum may simply be entered on the other user interface 23 or for example be obtained by optical read-out from an image.

The system 1 may be located locally (for example in the airport) but may also be separated into one or more remote cloud servers hosting the data-processing module 11, the data storage module 12 and the enrolment module 20, the data-processing module 11 being connected to the biometric acquisition means 14 which, for their part, must necessarily remain on site (typically at the boarding gate when it is a question of boarding control). In the example of FIG. 1, the enrolment module 20 and the data storage module 12 are remote.

When multiple remote cloud servers host the data-processing module 11, data storage module 12 and enrolment module 20, the communication between the servers may be wired or wireless, and uses any communication protocol (Wi-Fi, Bluetooth, etc.).

The user interface 13 and the biometric acquisition means 14 are connected to the data-processing module 11 by connecting means of any type, whether wired or not (Wi-Fi, Bluetooth, Ethernet, USB, etc.).

The other user interface 23, the other biometric acquisition means 24 and the document reader 26 are connected to the enrolment module 20 by connecting means of any type, whether wired or not (Wi-Fi, Bluetooth, Ethernet, USB, etc.).

The system 1 identifies the individual, i.e. compares the candidate personal datum (freshly acquired from the individual in the case of a biometric datum, or otherwise simply re-quested from the individual if it is an alphanumeric datum for example) with all the reference personal data of said database, in order to determine the identity of the individual.

The system 1 may lastly comprise access control means (for example an automatic door P in FIG. 1) controlled depending on the result of the identification: if an authorized user is recognized, access is permitted.

Said biometric acquisition means 14 may be mounted directly on said access control means.

The biometric acquisition means 14 make it possible to obtain a candidate biometric datum. Generally, the candidate biometric datum is generated by the data-processing module 11 from a biometric feature supplied by the biometric acquisition means 14; however, the biometric acquisition means 14 may comprise their own processing means and, for example, take the form of an automatic device provided by the authorities responsible for checks (in the airport) with a view to extracting the candidate biometric datum. A such biometric acquisition means may where appropriate encrypt the candidate biometric datum on the fly by applying an encryption function of the homomorphic cryptographic scheme into the form of candidate cryptograms (see the method described below). Thus, the candidate biometric data are also completely protected.

According to another possibility, the data-processing module 11 may encrypt the candidate biometric datum by applying an encryption function of the homomorphic cryptographic scheme into the form of candidate cryptograms.

Preferably, the biometric acquisition means 14 are capable of detecting liveness, so as to ensure that the candidate biometric datum has come from a “real” feature.

In the case where the biometric acquisition means 14 and the rest of the system are remote, the communication between the two may itself be encrypted.

The implementation of the comparison comprises calculation of a distance between the data. The distance between the data advantageously comprises the calculation of a scalar product.

This type of comparison and this type of distance are known to those skilled in the art and will not be described in more detail.

The individual is identified if the comparison reveals a degree of similarity between the candidate personal datum and a reference personal datum exceeding a certain threshold, the definition of which depends on the type of personal data.

FIG. 2 illustrates the steps of one embodiment of a method for processing personal data, according to the invention.

This method is here implemented by the system 1 and determines, in the encrypted domain, for each reference personal datum of a database, a distance between a given candidate personal datum X and said reference personal datum.

The distance between a candidate personal datum X and a reference personal datum is here the scalar product of the candidate personal datum and said reference personal datum.

The candidate personal datum X is a vector of l components (X[1], . . . , X[l]) having respective indices ranging from 1 to l, with l a natural number strictly greater than 1.

As explained, the database of reference personal data may have been populated in advance.

The system 1 stores a database of K reference personal data Y⁽¹⁾, . . . , Y^{(K)} that are homomorphically encrypted into the form of

$$⌈ \frac{K}{N} ⌉ \times l$$

reference cryptograms

$${C}_{Y}^{( 1 )} , … , {C}_{Y}^{( ⌈ \frac{K}{N} ⌉ \times l )}$$

in a group containing a first operation and a second operation, the first operation being an addition and the second operation being a multiplication, with K and N natural numbers strictly greater than 1.

Each reference personal datum, of the K reference personal data, is therefore stored homomorphically encrypted, typically by the data storage module 12.

For every p ranging from 1 to K, the reference personal datum Y^{(p)} of rank p is a vector of l components (Y^{(P)} [1], . . . , Y^{(P)} [l] having respective indices ranging from 1 to l.

For every q ranging from 1 to

$$⌈ \frac{K}{N} ⌉ \times l ,$$

the reference cryptogram

$${C}_{Y}^{( q )}$$

of rank q is a vector of N components

$$( {C}_{Y}^{( q )} [ 1 ] , ... , {C}_{Y}^{( q )} [ N ] )$$

having respective indices ranging from 1 to N.

As will be seen below, the invention is distinctive in that, for every i ranging from 1 to

$$⌈ \frac{K}{N} ⌉ ,$$

i.e. for every i ranging from 1 to the upper integer part of

$$\frac{K}{N} ,$$

and for every j ranging from 1 to l, the reference cryptogram

$${C}_{Y}^{( ( i - 1 ) \times l + j )}$$

of rank (i−1)×l+j is the image, by an encryption function of a homomorphic cryptographic scheme, of the concatenation of the components of index j of each reference personal datum having a rank between i×N−N+1 and i×N, i.e. ranks i×N−N+1 and i×N included.

According to another possibility, the database of reference personal data may not have been populated in advance.

In this respect, with reference to FIG. 2, the method may begin with a step (step E102) of obtaining the

$$⌈ \frac{K}{N} ⌉ \times l$$

reference cryptogram

$${C}_{Y}^{( 1 )} , ... , {C}_{Y}^{( ⌈ \frac{K}{N} ⌉ \times l )} ,$$

during which step, for every i ranging from 1 to

$$⌈ \frac{K}{N} ⌉$$

and for every j ranging from 1 to l, the reference cryptogram

$${C}_{Y}^{( ( i - 1 ) \times l + j )}$$

of rank (i−1)×l+j is obtained by applying the encryption function, to the concatenation of the components of index j of each reference personal datum having a rank between i×N−N+1 and i×N.

Typically, the reference cryptogram

$${C}_{Y}^{( ( i - 1 ) \times l + j )}$$

of rank (i−1)×l+j is calculated as follows:

$${C}_{Y}^{( ( i - 1 ) \times l + j )} = ENC ( ( {Y}^{( i \times N - N + 1 )} [ j ] , ... , {Y}^{( i \times N )} [ j ] ) )$$

with ENC the encryption function of the homomorphic cryptographic scheme.

For every p ranging from 1 to

$$N : {C}_{Y}^{( ( i - 1 ) \times l + j )} [ p ] = ENC ( {Y}^{( i \times N - N + p )} [ j ] ) .$$

When, for a value of t, there are not N reference personal data having a rank between i×N−N+1 and i×N, the reference cryptogram

$${C}_{Y}^{( ( i - 1 ) \times l + j )}$$

of rank (i−1)×l+j is obtained by applying the encryption function to the concatenation:
of the components of index j of each reference personal datum having a rank between i×N−N+1 and i×N, and
of any datum having the same format as a personal datum component for each of the other ranks between i×N−N+1 and i×N.

For example, if there are reference personal data for every rank between i×N−N+1 and i×N−2, but no reference personal data for ranks i×N−1 and i×N, the reference cryptogram

$${C}_{Y}^{( ( i - 1 ) \times l + j )}$$

of rank (i−1)×l+j is calculated as follows:

$${C}_{Y}^{( ( i - 1 ) \times l + j )} = ENC ( ( {Y}^{( i \times N - N + 1 )} [ j ] , ... , {Y}^{( i \times N - 2 )} [ j ] , {Q}_{1} , {Q}_{2} ) )$$

with ENC the encryption function of the homomorphic cryptographic scheme, Q₁ any first datum having the same format as a personal datum component and Q₂ any second datum having the same format as a personal datum component.

This step is typically implemented by the enrolment module 20.

Thus, this step may further comprise transmission to the data storage module 12, from the enrolment module 20, of the

$$⌈ \frac{K}{N} ⌉ \times l$$

reference cryptograms obtained.

The data storage module 12 stores the

$$⌈ \frac{K}{N} ⌉ \times l$$

reference cryptograms

$${C}_{Y}^{( 1 )} , … , {C}_{Y}^{( ⌈ \frac{K}{N} ⌉ \times l )} .$$

The

$$⌈ \frac{K}{N} ⌉ \times l$$

reference cryptograms

$${C}_{Y}^{( 1 〉} , … , {C}_{Y}^{( ⌈ \frac{K}{N} ⌉ \times l )}$$

form the homomorphically encrypted representation of the K reference personal data Y⁽¹⁾, . . . , Y^{(K)}.

The step (step E102) of obtaining the

$$⌈ \frac{K}{N} ⌉ \times l$$

reference cryptograms

$${C}_{Y}^{( 1 )} , … , {C}_{Y}^{( ⌈ \frac{K}{N} ⌉ \times l )}$$

may also comprise obtaining the K reference personal data.

In this case, according to a first advantageous example, each reference personal datum may be obtained from a datum recorded in an identity document of a reference individual, typically by the document reader 26, from a facial image featuring on an identity document (a passport for example), or indeed from an image of the face, of at least one iris or of at least one fingerprint of the individual recorded in a radio-frequency chip contained in the identity document.

According to a second example, each reference personal datum may be obtained by another biometric acquisition means 24, directly from a biometric feature of a reference individual.

According to a third example, if alphanumeric personal data are used, each reference personal datum may simply be entered on the other user interface 23 or for example be obtained by optical read-out from an image.

The method in itself begins with a step (step E104) of obtaining candidate cryptograms

$${C}_{X}^{( 1 )} , … , {C}_{X}^{( l )} ,$$

during which step, for every j ranging from 1 to l, a candidate cryptogram

$${C}_{X}^{( j )}$$

of rank j is obtained by applying the encryption function to the concatenation of N components each having the value of the component of index j of the candidate personal datum X[j].

Thus, the candidate cryptogram

$${C}_{X}^{( j )}$$

of rank j is the image, by the encryption function, of the concatenation of N components each having the value of the component of index j of the candidate personal datum X: X[j].

Typically, the candidate cryptogram

$${C}_{X}^{( j )}$$

of rank j is calculated as follows:

$${C}_{X}^{( j )} = ENC ( ( X [ j ] , … , X [ j ] ) )$$

with ENC the encryption function of the homomorphic cryptographic scheme.

For every p ranging from 1 to N:

$${C}_{X}^{( j )} [ p ] = ENC ( X [ j ] ) .$$

This step allows l candidate cryptograms to be obtained.

It is typically implemented by the data-processing module 11.

This step (step E104) of obtaining candidate cryptograms may further comprise obtaining the candidate personal datum.

In this case, according to a first advantageous example, the candidate personal datum may be obtained by a biometric acquisition means 14, directly from a biometric feature of a candidate individual.

According to a second example, if alphanumeric personal data are used, the candidate personal datum may simply be entered on the user interface 13 or for example be obtained by optical read-out from an image.

The method continues with a step (step E106) of determining, in the encrypted domain, the distances between the candidate personal datum X and each reference personal datum of the database.

This step is typically implemented by the data-processing module 11.

During this step, for every i ranging from 1 to

$$⌈ \frac{K}{N} ⌉ ,$$

the system 1 implements a processing operation of index i (processing operation T106_i) during which the system 1 determines, in the encrypted domain, the distances between the candidate personal datum X and each reference personal datum having a rank between i×N−N+1 and i×N.

Said processing operation of index i (processing operation T106_i) comprises:
a) for every j ranging from 1 to l, obtaining an intermediate cryptogram

$${C}_{X Y}^{( ( i - 1 ) \times l + j )}$$

of rank (i−1)×l+j taking the form of a vector of N components, by applying a Hadamard product between the reference cryptogram

$${C}_{Y}^{( ( i - 1 ) \times l + j )}$$

of rank (i−1)×l+j and a candidate cryptogram

$${C}_{X}^{( j )}$$

of rank j;
b) obtaining a final cryptogram

$${C}_{Z}^{( i )}$$

of rank i taking the form of a vector of N components, by applying a vector addition between the l intermediate cryptograms obtained.

In other words, during the processing for a given i (processing operation T106_i)
for every j ranging from 1 to l and for every p ranging from

$$N : {C}_{XY}^{( ( i - 1 ) \times l + j )} [ p ] = {C}_{Y}^{( ( i - 1 ) \times l + j )} [ p ] \times {C}_{X}^{( j )} [ p ] ;$$

for every p ranging from 1 to

$$N : {C}_{Z}^{( i )} [ p ] = {\sum }_{j = 1}^{l} {C}_{XY}^{( ( i - 1 ) \times l + j )} [ p ]$$

The calculation of a component of an intermediate cryptogram results from application of the second operation between a component of a reference cryptogram and a component of a candidate cryptogram.

The calculation of a component of a final cryptogram results from application of the first operation between components of l intermediate cryptograms.

The step (step E106) of determining, in the encrypted domain, the distances between the candidate personal datum X and each reference personal datum of the database therefore makes it possible to obtain

$$⌈ \frac{K}{N} ⌉$$

final cryptograms.

The distance between the candidate personal datum X and a reference personal datum Y^{(p)} of rank p is the antecedent, by the encryption function of the component of index

$$p - ( ⌈ \frac{p}{N} ⌉ - 1 ) \times N ,$$

of the final cryptogram of rank

$$⌈ \frac{p}{N} ⌉ : {C}_{Z}^{( ⌈ \frac{p}{N} ⌉ )} [ p - ( ⌈ \frac{p}{N} ⌉ - 1 ) \times N ] .$$

In other words:

$${C}_{Z}^{( ⌈ \frac{p}{N} ⌉ )} [ p - ( ⌈ \frac{p}{N} ⌉ - 1 ) \times N ] = ENC ( Dist ( X , {Y}^{( p )} ) )$$

with Dist(X, Y^{(p)}) the distance between the candidate personal datum X and the reference personal datum Y^{(p)} i.e. here the scalar product of the candidate personal datum X and said reference personal datum Y^{(p)}.

The processing operations of index i (processing operation T106_i), i ranging from 1 to

$$⌈ \frac{K}{N} ⌉ ,$$

thus determine in the encrypted domain the distances between the candidate personal datum X and each reference personal datum of the database.

The method makes it possible to limit the computation times and the memory space consumed by the system 1.

The method requires only

$$⌈ \frac{K}{N} ⌉ \times ( l - 1 )$$

applications of the vector addition between two intermediate cryptograms, i.e. application of

$$⌈ \frac{K}{N} ⌉ \times N \times ( l - 1 )$$

first operations between the components of different vectors, and does not require application of a rotation to the components of a vector. Nor does the method require application of the first operation between components of the same vector. Lastly, the distance between the candidate personal datum and a reference personal datum of a given rank corresponds to one and only one final cryptogram component.

It will be noted that, according to one possible implementation, all the processing operations of index i (processing operation T106_i), i ranging from 1 to may be executed

$$⌈ \frac{K}{N} ⌉ ,$$

sequentially by the system 1.

According to another possible implementation, a plurality of processing operations of index i (processing operation T106_i), i ranging from 1 to

$$⌈ \frac{K}{N} ⌉ ,$$

may be executed in parallel by the system 1, for example by means of a processor comprising a plurality of cores, each core being configured to execute at least one processing operation of the plurality, and/or by means of a plurality of processors, each processor being configured to execute at least one processing operation of the plurality.

The method may further comprise a step (step E108) of decrypting the final cryptograms.

Each final cryptogram is decrypted by applying a decryption function of the homomorphic cryptographic scheme, to the final cryptogram in question or to the components of said final cryptogram in question.

The method thus makes it possible to obtain, for each reference personal datum of the database, a cleartext distance between the candidate personal datum and said reference personal datum, while limiting computation times and the memory space consumed. The distance between the candidate personal datum and a reference personal datum corresponds merely to one and only one final cryptogram component. The method therefore does not decrypt redundant components and/or does not require selection of the final cryptogram components to be decrypted.

The method may further continue with a step (step E110) of determining a check result, during which step the system 1 determines whether a distance between the candidate personal datum and a reference personal datum of the database exceeds a predetermined threshold.

Under these conditions, the system 1 (typically the data-processing module 11) may, in an access control step (step E112), order the gate P to open in order to allow the candidate individual to access a secure area.

This step (step E110) of determining a check result is typically implemented by the data-processing module 11.

In practice, the check result may be a Boolean.

The system 1 may determine the check result from cleartext distances obtained during the step (step E108) of decrypting the final cryptograms.

According to another possibility, the system 1 may determine the check result directly from components of final cryptograms, by operating in the group of the homomorphic cryptographic scheme, i.e. in the encrypted domain. In this case, the step (step E108) of decrypting the final cryptograms may be omitted.

As already indicated, any homomorphic cryptographic scheme having the required properties may be used, for example the Brakerski-Fan-Vercauteren (BFV) scheme or the Cheon-Kim-Kim-Song (CKKS) scheme.

When the system is able to perform parallel computing, it for example having an SIMD architecture, allowing a given operation to be carried out on M data, the value of N is preferably:
M if the homomorphic cryptographic scheme is the Brakerski-Fan-Vercauteren scheme;

$$⌊ \frac{M}{2} ⌋$$

if the homomorphic cryptographic scheme is the Cheon-Kim-Kim-song scheme, i.e. the lower integer part of

$$\frac{M}{2} .$$

The method is thus optimized for parallel-computing ability of the system.

Furthermore, K is preferably a multiple of N. In this case, there is a non-zero integer such that K is equal to the product of this non-zero integer by N.

The temporal performance of the method is thus optimal, each component of each reference cryptogram being the image, by the encryption function, of one component of a reference personal datum.

Advantageously, the personal data are biometric data, in particular data representative of faces.

One particular application of the method, in which the result of the check is a condition for accessing a secure area, has been discussed above. However, it will be understood that the described method may be used for other applications.

1. A method for processing personal data implemented by a system storing a database of K reference personal data that are homomorphically encrypted into the form of
$$⌈ \frac{K}{N} ⌉ \times l$$
reference cryptograms in a group containing a first operation and a second operation, said method comprising:
determination determining, in the encrypted domain, for each reference personal datum of the database, a distance between a given candidate personal datum and said reference personal datum,
wherein the first operation is an addition and the second operation is a multiplication,
for every p ranging from 1 to K, the reference personal datum of rank p is a vector of l components having respective indices ranging from 1 to l,
for every q ranging from 1 to
$$⌈ \frac{K}{N} ⌉ \times l ,$$
the reference cryptogram of rank q is a vector of N components having respective indices ranging from 1 to N, and
the candidate personal datum is a vector of l components having respective indices ranging from 1 to l, with K, N and 1 natural numbers strictly greater than 1, wherein:
for every i ranging from 1 to
$$⌈ \frac{K}{N} ⌉$$
and for every j ranging from 1 to l, the reference cryptogram of rank (i−1)×l+j is the image, by an encryption function of a homomorphic cryptographic scheme, of the concatenation of the components of index j of each reference personal datum having a rank between i×N−N+1 and i×N, and
for every i ranging from 1 to
$$⌈ \frac{K}{N} ⌉ ,$$
the determination in the encrypted domain of the distances between the candidate personal datum and each reference personal datum having a rank between i×N−N+1 and i×N comprises:
(a) for every j ranging from 1 to l, obtaining an intermediate cryptogram of rank (i−1)×l+j taking the form of a vector of N components, by applying a Hadamard product between the reference cryptogram of rank (i−1)×l+j and a candidate cryptogram of rank j, the candidate cryptogram of rank j being the image, by the encryption function, of the concatenation of N components each having the value of the component of index j of the candidate personal datum, and
(b) obtaining a final cryptogram of rank i taking the form of a vector of N components, by applying a vector addition between the l intermediate cryptograms obtained,
the distance between the candidate personal datum and a reference personal datum of rank p being the antecedent, by the encryption function of the component of index
$$p - ( ⌈ \frac{p}{N} ⌉ - 1 ) \times N ,$$
of the final cryptogram of rank
$$⌈ \frac{p}{N} ⌉ .$$

2. The method for processing personal data as claimed in claim 1, further comprising a step of obtaining the
$$⌈ \frac{K}{N} ⌉ \times l$$
reference cryptograms, during which step, for every i ranging from 1 to
$$⌈ \frac{K}{N} ⌉$$
and for every j ranging from 1 to l, the reference cryptogram of rank (i−1)×l+j is obtained by applying the encryption function, to the concatenation of the components of index j of each reference personal datum having a rank between i×N−N+1 and i×N.

3. The method for processing personal data as claimed in claim 1, further comprising a step of obtaining the candidate cryptograms, during which step, for every j ranging from 1 to l, the candidate cryptogram of rank j is obtained by applying the encryption function to the concatenation of N components each having the value of the component of index j of the candidate personal datum.

4. The method for processing personal data as claimed in claim 1, wherein the candidate personal datum is acquired using an acquisition interface.

5. The method for processing personal data as claimed in claim 1, the method further comprising of decrypting the final cryptograms.

6. The method for processing personal data as claimed in claim 1, wherein the personal data are biometric data being data representative of faces.

7. The method for processing personal data as claimed in claim 1, wherein K is a multiple of N.

8. The method for processing personal data as claimed in claim 1, wherein the homomorphic cryptographic scheme is the Brakerski-Fan-Vercauteren scheme or the Cheon-Kim-Kim-Song scheme.

9. A non-transitory computer-readable medium storing a computer program comprising instructions executable by a processor and configured to implement the method for processing personal data as claimed in claim 1, when the instructions are executed by the processor.

10. A non-transitory computer-readable medium storing instructions that are able to be executed by a processor so as to execute the method for processing personal data as claimed in claim 7.

11. A system for processing personal data, the system comprising:
a data storage storing a database of K reference personal data that are homomorphically encrypted into the form of
$$⌈ \frac{K}{N} ⌉ \times l$$
reference cryptograms in a group containing a first operation and a second operation, and
a data-processing circuit configured to determine, in the encrypted domain, for each reference personal datum of the database, a distance between a given candidate personal datum and said reference personal datum, wherein:
the first operation is an addition and the second operation is a multiplication,
for every p ranging from 1 to K, the reference personal datum of rank p is a vector of l components having respective indices ranging from 1 to l,
for every q ranging from 1 to
$$⌈ \frac{K}{N} ⌉ \times l ,$$
the reference cryptogram of rank q is a vector of N components having respective indices ranging from 1 to N, and
the candidate personal datum is a vector of l components having respective indices ranging from 1 to l,
with K, N and l natural numbers strictly greater than 1, wherein:
for every i ranging from 1 to
$$⌈ \frac{K}{N} ⌉$$
and for every j ranging from 1 to l, the reference cryptogram of rank (i−1)×l+j is the image, by an encryption function of a homomorphic cryptographic scheme, of the concatenation of the components of index j of each reference personal datum having a rank between i×N−N+1 and i×N, and
for every i ranging from 1 to
$$⌈ \frac{K}{N} ⌉ ,$$
the determination in the encrypted domain, by the data-processing module (11), of the distances between the candidate personal datum and each reference personal datum having a rank between i×N−N+1 and i×N, comprises:
(a) for every j ranging from 1 to l, obtaining an intermediate cryptogram of rank (i−1)×l+j taking the form of a vector of N components, by applying a Hadamard product between the reference cryptogram of rank (i−1)×l+j and a candidate cryptogram of rank j, the candidate cryptogram of rank j being the image, by the encryption function, of the concatenation of N components each having the value of the component of index j of the candidate personal datum, and
(b) obtaining a final cryptogram of rank i taking the form of a vector of N components, by applying a vector addition between the l intermediate cryptograms obtained,
the distance between the candidate personal datum and a reference personal datum of rank p being the antecedent, by the encryption function of the component of index
$$p - ( ⌈ \frac{p}{N} ⌉ - 1 ) \times N ,$$
of the final cryptogram of rank
$$⌈ \frac{p}{N} ⌉ .$$

12. The system for processing personal data as claimed in claim 1, further comprising an acquisition interface configured to acquire the candidate personal datum.
